(19) United States
(12) Patent Application Publication
(10) Pub. No.: US 2014/0181744 A1
(43) Pub. Date: Jun. 26, 2014

(54) Method and Software for Bringing the Conscience of a Person to a Physical State

(71) Applicant: Derrick Rivers, JR., Jonesboro, GA (US)

(72) Inventor: Derrick Rivers, JR., Jonesboro, GA (US)

(21) Appl. No.: 14/139,223

(22) Filed: Dec. 23, 2013

Related U.S. Application Data
(60) Provisional application No. 61/848,082, filed on Dec. 26, 2012.

(51) Int. Cl. G06F 3/0481; G09B 5/02; G06F 3/0484

(52) U.S. Cl. CPC G06F 3/04817; G06F 3/04842; G09B 5/02
USPC 715/826; 434/236

(57) ABSTRACT

The present inventive concept relates to an electronic device and method for inducing a person's conscience into expression as a physical state of being. A primary object of the present inventive concept is to accurately induce an emotion desired by a user by feedbacking stored electronic data in a mobile phone or electronic device owned by a user and generating awareness of the inducement of a desired emotion in accordance with activation of one of a menu of selection icons displayed on the screen of the device. The object of the invention can be achieved by enabling the user to select the desired emotion or personal concern icon, thereby outputting those signals which provide digitally-stored displays on the monitor of the device. In this manner, the user's conscience is stimulated to produce the physical state of body presence that the user desires.

### CROSS-REFERENCE TO RELATED APPLICATIONS

This patent application claims the benefit of priority from previously-filed U.S. provisional patent application, Ser. No. 61/848,082 filed on Dec. 26, 2012, and claims the content of said provisional application as though fully appearing herein.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The present invention relates to an electronic device and method for inducing emotions in a user which can prod the user's conscience and in turn generate a particular reaction or state of mind. More particularly, the device and method produce visual and/or auditory signals that are ingested by the user and thereby direct the user's focus on those areas of his/her conscience that needs enhancing in a beneficial manner.

(2) Description of the Related Art, Including Information Disclosed under 37 CFR 1.97 and 1.98

An emotion generally means a mental state that is expressed as a change in feelings and a change in physiological activation due to an internal or external stimulus. As to the various emotions, there are positive emotions such as love, ecstasy, satisfaction, or kindliness, and negative motions such as sadness, anger, fear, or disgust.

There have been proposed various models for emotion induction and human behavior according to methods of analyzing an emotion and relationships between the emotion and the autonomic nervous system in view of psychology. Also in this field of endeavor are various self-improvement type computerized programs to assist a user in different areas of everyday living. The following are examples of references in this field:

US #2013/0322748 A1 (Dec. 5, 2013) Method and apparatus for creating a thumbnail image of a video in an electronic device are provided. The method for creating the video thumbnail image in the electronic device includes detecting a plurality of image in a video; selecting at least one image by considering a color attribute of the images; and displaying the at least one image as a thumbnail image of the video.

U.S. Pat. No. 7,955,259 B2 (Jun. 7, 2011) The present invention relates to an apparatus and method for inducing emotions. A primary object of the present invention is to accurately induce an emotion desired by a user by feedbacking biosignals from the user and inducing a desired emotion in accordance with the feedback biosignals. The object of the invention can be achieved by allowing the user to select the desired emotion, outputting physical signals for stimulating the user's body based on an emotion induction protocol capable of inducing the selected emotion.

US #2006/0111621 A1 (May 25, 2006) Systems and methods for sonification, user influence through sound, and biofeedback, sonification of motion and physiological parameters during physical exercise and the use of music and sound in order to influence the emotional, psychological and physiological state of an exerciser, and the use of sonification and influence in a feedback loop to create a particular exercise experience for a user. A digital music player comprises physiological sensors, a controller, a user interface, a music decoder, a music playback modulator, and an audio data store.

US 2007/0173705 A1 (Jul. 26, 2007) The invention is a system for monitoring and reporting the activity level and caloric expenditure of an individual. The system has sensors in electronic communication with a wearable device. A processor is programmed to communicate with the sensor and a computing device to activity data from movement-related data. A remote server receiving the activity data and the data from computing device, and generates a graphical presentation. The graphical presentation comprises information related to the activity data. The wearable device also provides visual and audio data.

US #2007/0167689 A1 (Jul. 19, 2007) A method (50) of altering content provided to a user includes the steps of creating (60) a user profile based on past physiological measurements of the user, monitoring (74) at least one current physiological measurement of the user, and altering (82) the content provided to the user based on the user profile and the at least one current physiological measurement. The user profile can be created by recording a plurality of inferred or estimated emotional states (64) of the user which can include a time sequence or emotional states, stimulus contexts for such states, and a temporal relationship between the emotional state and the stimulus context.

U.S. Pat. No. 6,186,145 B1 (Feb. 13, 2001) Methods and systems for monitoring, diagnosing and/or treating psychological conditions and/or disorders in patients with the aid of computer-based virtual reality simulations. Pursuant to one preferred embodiment, a computer program product is used to control a computer. The program product includes a computer-readable medium, and a controlling mechanism that directs the computer to generate an output signal for controlling a video display device. The video display device is equipped to display representations of three-dimensional images, and the output signal represents a virtual reality simulation directed to diagnosis and/or treatment of a psychological condition and/or disorder.

U.S. Pat. No. 5,253,168 (Oct. 12, 1993) A system for allowing an individual to express themself in a creative manner by using biofeedback signals to direct imaging and audio devices.

U.S. Pat. No. 5,076,281 (Dec. 31, 1991) A biorhythm modulator, consisting of a sensor for monitoring biorhythmic activity of the body of a user. A method for modulating biorhythmic activity is also described.

U.S. Pat. No. 4,461,301 (Jul. 24, 1984) A bio-feedback method for training persons in the self-regulation of physiological functions by means of displaying to the person a continuous representation of a value of such physiological functions upon, and together with, a metric which is continuously and automatically variable as a function of such values and the rate of change of such values so as to provide to the person a display in which changes in the physiological function are highly resolvable and therefore easily noticed.

### BRIEF SUMMARY OF THE INVENTION

A primary objective of the inventive concept disclosed is a mind-expanding idea to bring about beneficial change in a person's everyday life. It is intended to change how individuals motivate themselves, in addition to changing, work ethic, love life, perception of other persons, and the manner in which persons react when confronted with day-to-day challenges of life. The inventive concept will assist teachers and anyone that inspires youth to be successful. The method disclosed is available for use by a person at any minute or hour of the day, provided a compatible electronic device is reasonably accessible, to provide counseling, support, motivation, and consolation, if necessary. A person's stressful situations become moments of pleasure, and nurture dreams into actual accomplishments.

The inventive concept is commercially known as “Conscience,” and is a mobile application for iOS®, and Android™. The device disclosed is further compatible with iPhone®, iPod®, iPad®, and Android Phones and Tablets. This inventive concept is designed to bring a user's conscience to expression as a physical state to help celebrate and overcome all obstacles that are presented in everyday life.

### BRIEF DESCRIPTION OF THE VIEWS OF THE DRAWINGS

FIG. 1 presents the “home page” displaying icons that appear on an electronic device when a person uses the device for initial (or intermittent) access to the content of the inventive concept, “Conscience.”

FIG. 2 is a flow chart representing the choices available to a user in accessing those images which impact the conscience.

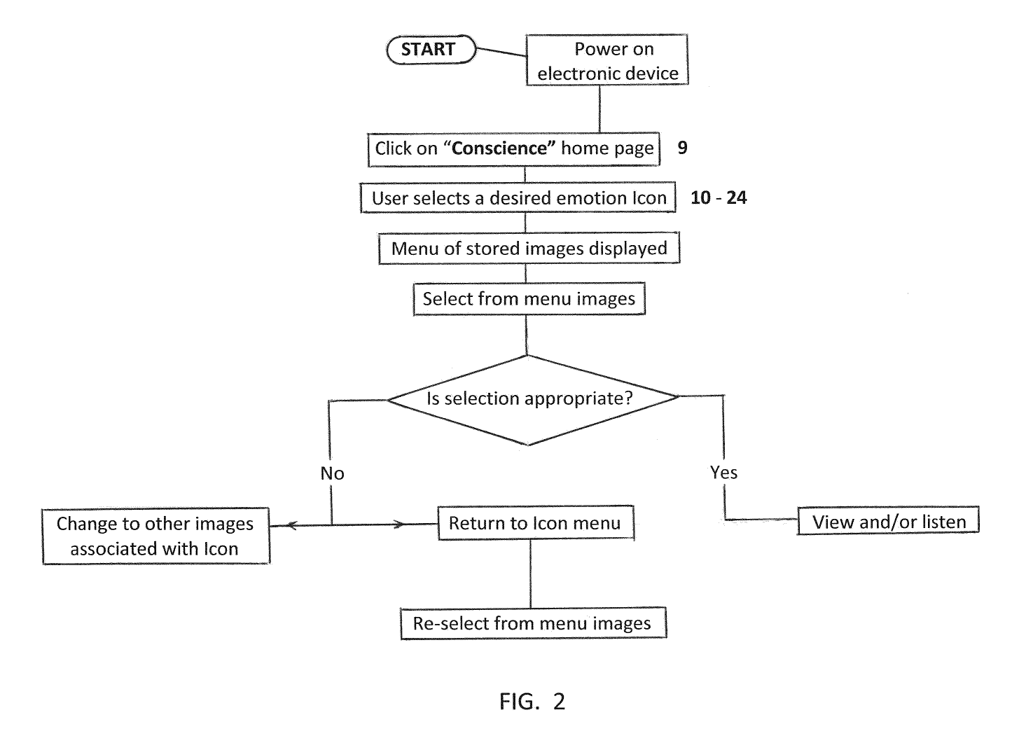

FIG. 3 is a flow chart further clarifying the selections available to a user regarding the necessity of editing or sharing content of the images available on the “Conscience” software.

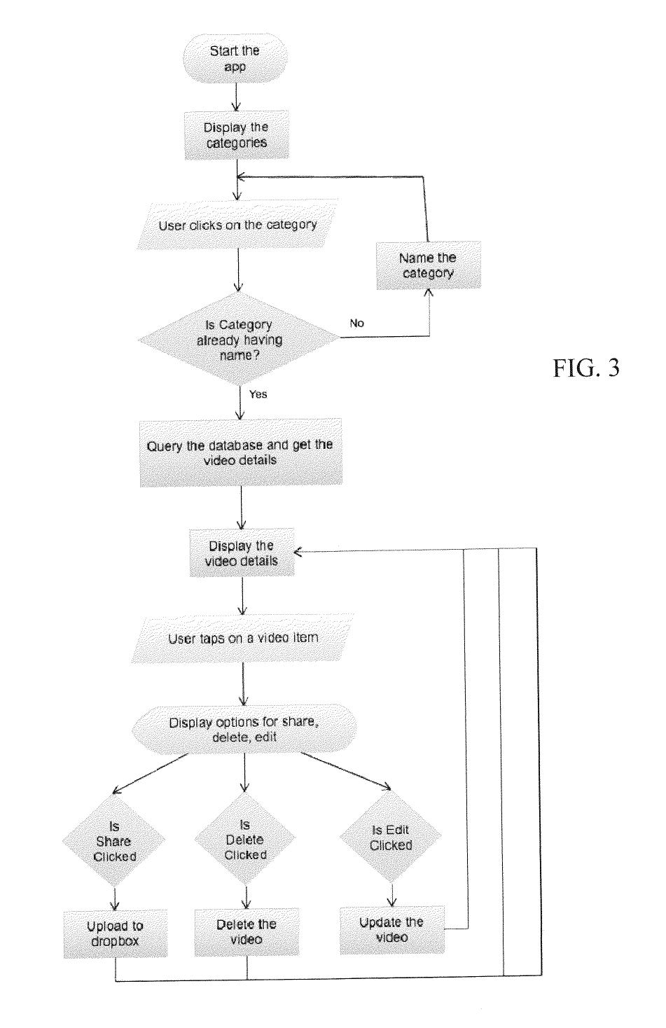

Table of Nomenclature & Part Numbers of Invention

```
  1. Electronic device
  2.-8. n/a
  9. “Home page” of device
10. “Love” Icon
11. “Sad” Icon
12. “Nervous” Icon
13. “Goals” Icon
14. “Happy” Icon
15. “Funny” Icon
16. “Discipline Icon
17. “Thankful” Icon
18. “Peaceful” Icon
19. “Jokes” Icon
20. “Picture” Icon
21. “Pets” Icon
22. First custom Icon
23. Second custom Icon
24. Third custom Icon
```

### DETAILED DESCRIPTION OF THE INVENTIVE CONCEPT

The objects, features, and advantages of the concept presented in this application are more readily understood when referring to the accompanying drawings. The drawings, totaling three figures, show the basic components and functions of embodiments and/or methods of use. In the several figures, like reference numbers are used in each figure to correspond to the same component as may be depicted in other figures.

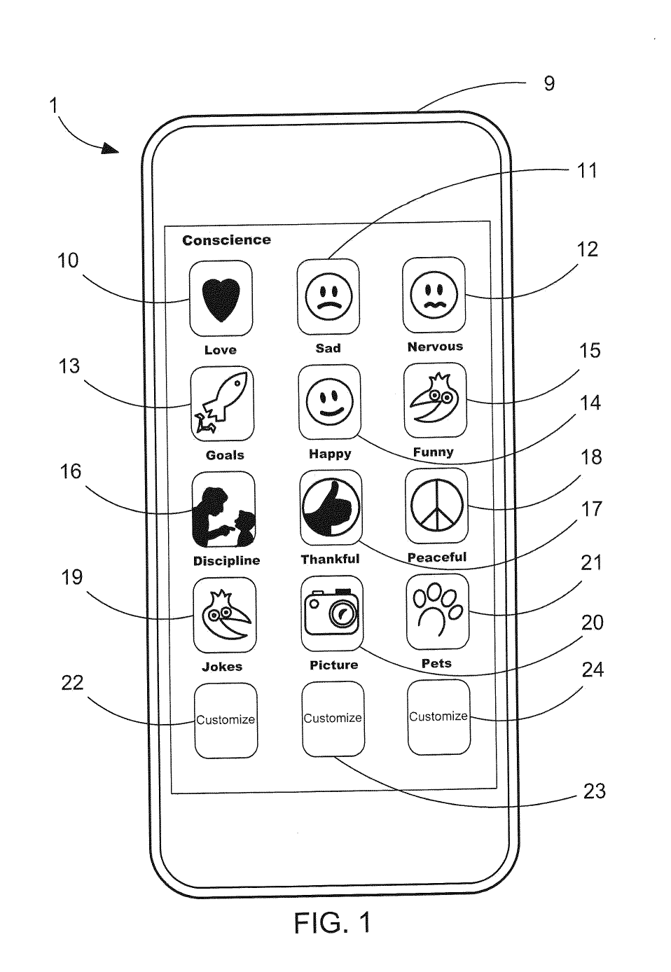

The discussion of the present inventive concept will be initiated with FIG. 1, which illustrates presents the “home page” 9 displaying Icons 10-24 that appear on an electronic device 1 that has the Conscience application installed on the device. This home page 9 comes into view when a person initially turns on the device and selects the Conscience program or when during use, the person intermittently desires to accesses different categories of the Conscience program.

A user takes the following steps to upload the Conscience operating system:
1. Turn on the specific electronic device 1;
2. Download the software provided to a purchaser through a specially programmed online website, and install the software on the device 1;
3. Record messages which are inspirational and personally instructional in nature when there exist conditions of emotional duress, weakness, or stress by the user;
4. Record the user's family, acquaintances, or friends during exceptional times of happiness or joy;
5. Select a variety of background videos, artwork, or photographs corresponding to the user's liking;
6. If desired, customize any or all of the designated Icons 22 through 24 in accordance with the expected emotional needs or circumstances of the user;
7. Prepare mentally for the expected conveyance of emotions stemming from the selections made in steps 3 through 5, above;
8. Repeat any of the foregoing steps 3 through 5, above, in accordance with the need of the user's conscience.

The user of the device 1 then makes the assignment and uploading of data in the digital memory space allotted to each particularly appropriate icon 10 through 23, as follows:

On the “Love” Icon 10, the user records him/herself, their family, friends, other persons, objects, which can visually and or audibly express how the person or object feels about the user and any conveyance of gratitude that the person/object generates toward the user.

On the “Sad” icon 11, the user records him/herself, their family, friends, other persons, objects, which can visually and or audibly cause an uplifting sensation at a time when sadness prevails in the person's conscience.

On the “Nervous” icon 12, the user records him/herself, their family, friends, other persons, objects, which can visually and or audibly express the type of motivation likely to lead to a calming state of mind for the user.

On the “Goals” icon 13, the user records him/herself, family, friends, other persons, and objects that bring about an awareness of genuine support for the user's accomplishments or future aspirations.

On the “Happy” icon 14, the user records him/herself, their family, friends, other persons, objects, which bring about emotions of joy or happiness.

On the “Funny” Icon 15, there is recorded by the user, images of him/herself, persons, or objects that present comical recollections or generate laughter from the user.

On the “Discipline” icon 16, the user records those persons that are familiar with the misdeeds, errant behavior, or mistakes committed by the users and, by means of recollection of that person(s)' presence, could stimulate the conscience of the user to activate a course of good behavior, repentance, or corrective actions.

On the “Thankful” Icon 17, a user can record him/herself, persons, things, or occurrences which generate a feeling of appreciation of life's events, of the user's own person, or of family, friends, or acquaintances.

On the “Peaceful” icon 18, a user can record him/herself, persons, things, or occurrences which generate a deep feeling of contentment and inner stillness.

On the “Jokes” Icon 19, the user may record pranks, jokes, comedians, and persons or situations that generate laughter.

On the “Picture” icon 20, the user can record photographs or artwork of persons, places, or object that have a significant effect on the person's life.

On the “Pets” icon 21, various images revealing demonstrations of love between a human and an animal may be recorded.

On the first “Customize” Icon 22, a user need only press to click on a program associated with this icon, then follow instructions for creating and titling a new category of Conscience materials and choices coordinating with the selected title of the custom Icon. Likewise, with the second and third “Customize” Icons 23 and 24, storage space is made available for creating a newly-titled subject, and the uploading of materials into that category.

When uploading material for the Conscience inventive concept in iOS, all the data is stored in “plist” file format (“Property List”). “Plist” is a file that stores the data in “serialized” objects. In the Conscience application, the plist which is utilized has the following structure:

### Root

Category (NSDictionary)
Name (NSString)
Image_iPad (NSString)
Image_iPhone (NSString)
Videos (NSArray)
Video (NSDictionary)
Title (NSString)
Description (NSString)

When clicking on any category of the Icons 10-24 on the home page 9, there will be displayed a menu of the details of the videos or other media available in that category. Every category will have an introductory video which cannot be edited or deleted. Upon accessing the introductory video, a “+” will be displayed, which when clicked on, will allow the user to add more video or material to the category. The user must then record the video, enter a name for it, and a short description.

While preferred embodiments of the present inventive concept have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the an without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and is by no means limited by the scope of the claims presented herein.

What is claimed is:

1. An electronic device, which may be any device among a mobile phone, a smart phone, a PDA, a laptop computer, an iPad®, or similar device, for teaching a human subject self-identification and optimization of the uplifting segments of the subject's conscience by means of accessing pre-selected stimuli stored in said device, comprising:
a plurality of digitally stored images, within said device, of matters, places, objects, persons and/or occurrences that by their content, engender a profound effect on the conscience of said subject;
a plurality of digitally stored auditory and/or visual images and renderings of matters, places, objects, persons, and occurrences that have a substantial impact on the conscience of the subject's well-being;
at least fifteen icons on a “home page” of said device, representing fifteen separate categories of personal emotional states that are deemed valuable and essential to the subject, said icons titled “Love,” “Sad,” “Nervous,” “Goals,” “Happy,” “Funny,” “Discipline,” “Thankful” “Peaceful,” “Jokes,” “Picture,” “Pets,” and further, three icons each titled “Customize;”
a grouping of said images into at least fifteen (15) categories of emotional condition, said categories corresponding to the title of the Icons which are accessible on the first page of the electronic communications device;
a means, whereupon by pressing a specific icon, the state of displaying the icons on the home page of the device is switched to the state of displaying an access menu to the available images stored in correspondence with the title of the Icon selected;
an electronic means by which the subject may change the title of any of the three “Customize” Icons to correspond to any additional emotional or personal need of the subject and a means to upload images appropriate to each of the newly-titled “Customize” Icons;
a digitally stared, on a plurality of electronic pages, visual and/or auditory media that correspond to the various separate images that have been previously stored in the device;
(d) separate electronic memory caches associated with each of the fifteen categories of personal emotional states;

2. A method of teaching a human subject self-identification and optimization of the uplifting segments of the subject's conscience by means of accessing pre-selected stimuli, said stimuli comprising digitally stored auditory and visual renderings of matters, places, objects, persons, and occurrences that have a substantial impact on the conscience of the subject's well-being, comprising the steps of
(a) introducing or downloading a specially designed application program onto the subject's own electronic device of a type which may comprise a mobile phone, a smart phone, a PDA, a laptop computer, an iPad®, a desktop computer, or similar device;
(b) providing, by means of the downloaded program, a digitized first page, or “home page” containing at least fifteen (15) titled Icons representing fifteen separate categories of personal emotional states that are deemed valuable and essential to the increased awareness of the conscience and the well-being of the subject, said categories being “Love,” “Sad,” “Nervous,” “Goals,” “Happy,” “Funny” “Discipline,” “Thankful,” “Peaceful,” “Jokes,” “Picture,” “Pets,” and further, three icons each titled “Customize;
(c) selecting or creating a plurality of digitally stored images of matters, places, objects, persons and/or occurrences that engender a profound effect on the conscience of said subject;
(d) organizing and grouping said images into at least fifteen (15) categories of emotional condition, said categories corresponding to the title of the Icons which are accessible on the first page of the electronic communications device;
(e) providing a separate electronic memory cache associated with each of the fifteen categories of personal emotional states;
(f) providing electronic means to change the title of any of the three “Customize” Icons to correspond to any additional emotional or personal need of the subject and a means to upload images appropriate to each of the newly-titled “Customize” icons;
(g) providing, on a digitized second page, sub-icons that correspond to the separate images that have been accrued;
(h) manually determining, for each rendering in the various categories, a priority ordering of those images which evoke the strongest reactions affecting said specific subject's conscience;
(i) displaying, by the pressing of a specific icon at the discretion of the subject, those images within the Icon category selected which induce a desired effect on the conscience of the subject.

3. A software program product causing an electronic device of a type which may comprise a mobile phone, a smart phone, a PDA, a laptop computer, an iPad®, a desktop computer, or similar device, which enables the device, through user input, to implement the steps of:
(a) displaying a digitized first page, or “home page” containing at least fifteen (15) titled icons representing fifteen separate categories of personal emotional states that are deemed valuable and essential to the cleansing of the conscience and the well-being of the subject, said categories being “Love,” “Sad,” “Nervous,” “Goals,” “Happy,” “Funny,” “Discipline,” “Thankful,” “Peaceful,” “Jokes,” “Picture,” “Pets,” and further, three icons each titled “Customize;
(b) creating, generating, and storing in an internal memory of the device, a set of images of matters, places, objects, persons and/or occurrences that engender a profound effect on the conscience of said subject;
(c) organizing and grouping said images into at least fifteen (15) categories of emotional condition, said categories corresponding to the title of the Icons which are accessible on the first page of the electronic communications device;
(d) providing, on a plurality of digitized pages, visual and/or auditory media that correspond to the various separate images that have been previously stored in the device;
(e) providing a separate electronic memory cache associated with each of the fifteen categories of personal emotional states;
(e) providing electronic means to change the title of any of the three “Customize” icons to correspond to any additional emotional or personal need of the subject and a means to upload images appropriate to each of the newly-titled “Customize” Icons;
(f) upon the subject pressing a specific Icon, switching the state of displaying the Icons on the home page of the device to the state of displaying the available images stored in correspondence with the title of the Icon selected;
